(19) United States
(12) Patent Application Publication
(10) Pub. No.: US 2025/0019509 A1
(43) Pub. Date: Jan. 16, 2025

(54) METHOD FOR TREATING POLYIMIDE

(71) Applicant: GOODWIN PLC, Staffordshire (GB)

(72) Inventors: Michael Gerard PALIN, Staffordshire (GB); Matthew Stanley GOODWIN, Staffordshire (GB); Philip LONGFIELD, Staffordshire (GB)

(21) Appl. No.: 18/714,041

(22) PCT Filed: Nov. 29, 2022
(86) PCT No.: PCT/GB2022/053013

§ 371 Date: May 29, 2024

(30) Foreign Application Priority Data
Nov. 29, 2021 (GB) 2117218.4

(51) Int. Cl. C08J 7/12; C08K 3/04; C08K 9/10

(52) U.S. Cl. CPC C08J 7/12; C08K 3/04; C08K 9/10; C08J 2379/08

(57) ABSTRACT

Disclosed is a method of treating a polyimide, comprising: providing a polyimide to be treated; and contacting the polyimide to be treated with a fluid to obtain a treated polyimide; wherein the polyimide comprises a first repeat unit derived from pyromellitic dianhydride (PMDA) and a second repeat unit derived from 4,4′-oxodianiline (4,4′-ODA); and wherein the fluid comprises a supercritical fluid, a liquid with a surface tension of 10.0 mN m″1 or less under the conditions of the contacting step, or a mixture thereof. Also disclosed are polyimides obtainable by the methods of the invention, formed polyimide products comprising the polyimides of the invention, and articles comprising the formed polyimide products of the invention.

### FIELD OF THE INVENTION

The present invention relates to methods for treating polyimides, polyimides obtainable by the methods of the invention, formed polyimide products comprising the polyimides of the invention, and articles comprising the formed polyimide products of the invention.

### BACKGROUND TO THE INVENTION

Polyimides are well known as durable high performance polymers with applications in fields such as aerospace, automotive, and oil and gas industries. Typical characteristics of polyimide materials include heat resistance, lubricity, dimensional stability, chemical resistance and creep resistance. Such known polyimides are described in U.S. Pat. Nos. 3,249,588, 3,179,631, and 4,755,555, for example, and have been commercially available for many years, such as the Vespel® SP product range from DuPont and Meldin® 7000 product range from Saint-Gobain performance plastics, that conform to ASTM standard D6456-10 (Standard Specification for Finished Parts Made from Polyimide Resin).

The continuing engineering challenges faced in fields such as aerospace, automotive and heavy industries mean it is desirable to provide polyimide materials having improved mechanical properties, especially at higher temperatures. From environmental and economic perspectives it is also desirable to provide processes which enable a reduction in volatile organic compound (VOC) use, and also which enable recovery and re-use of the majority of agents used in the processing of polyimide materials.

### SUMMARY OF THE INVENTION

The present invention aims to provide a solution to the problems discussed above. In particular, the present invention provides a method of treating a polyimide, comprising: providing a polyimide to be treated; and contacting the polyimide to be treated with a fluid to obtain a treated polyimide; wherein the polyimide comprises a first repeat unit derived from pyromellitic dianhydride (PMDA) and a second repeat unit derived from 4,4′-oxodianiline (4,4′-ODA); and wherein the fluid comprises a supercritical fluid, a liquid with a surface tension of 10.0 mN m⁻¹ or less under the conditions of the contacting step, or a mixture thereof, and wherein the method optionally further comprises a step of mixing the treated polyimide with an additive to obtain a polyimide mixture.

The present invention also provides a method of forming a treated polyimide of the invention or the polyimide mixture of the invention to obtain a formed polyimide product.

The present invention also provides a treated polyimide, a polyimide mixture, and a formed polyimide product obtainable by the methods of the present invention.

The present invention also provides a polyimide having a BET specific surface area greater than 100 m² g⁻¹, wherein the polyimide comprises a first repeat unit derived from pyromellitic dianhydride (PMDA) and a second repeat unit derived from 4,4′-oxodianiline (4,4′-ODA), and wherein the polyimide does not comprise a encapsulated filler or comprises an encapsulated filler in an amount of 20 wt % or less relative to the weight of the polyimide.

The present invention also provides a polyimide having a BET specific surface area greater than 70 m² g⁻¹, wherein the polyimide comprises a first repeat unit derived from pyromellitic dianhydride (PMDA) and a second repeat unit derived from 4,4′-oxodianiline (4,4′-ODA), and wherein the treated polyimide comprises an encapsulated filler in an amount of 20 wt % to 60 wt % relative to the weight of the polyimide.

The present invention also provides a direct formed crystalline polyimide product wherein the polyimide comprises a first repeat unit derived from pyromellitic dianhydride (PMDA) and a second repeat unit derived from 4,4′-oxodianiline (4,4′-ODA), and wherein the direct formed crystalline polyimide product:
does not comprise an encapsulated filler, comprises 0 wt % to 0.5 wt % of an additive relative to the weight of the polyimide, and has a tensile strength of 80.0 MPa or greater; or
comprises 10 wt % to 20 wt % of an encapsulated filler relative to the weight of the polyimide, comprises 0 wt % to 0.5 wt % of an additive relative to the weight of the polyimide, and has a tensile strength of 63.0 MPa or greater; or
comprises 20 wt % to 60 wt % of an encapsulated filler relative to the weight of the polyimide, comprises 0 wt % to 2.0 wt % of an additive relative to the weight of the polyimide, and has a tensile strength of 50.0 MPa or greater; or
comprises 10 wt % to 20 wt % of an encapsulated filler relative to the weight of the polyimide, comprises 5 wt % to 15 wt % of an additive relative to the weight of the polyimide, and has a tensile strength of 52.5 MPa or greater; or
comprises 20 wt % to 60 wt % of an encapsulated filler relative to the weight of the polyimide, comprises 10 wt % to 20 wt % of an additive relative to the weight of the polyimide, and has a tensile strength of 39.5 MPa or greater.

The present invention also provides a hot isostatically pressed crystalline polyimide product, ram extruded (that may optionally be subsequently hot isostatically pressed) crystalline polyimide product, or hot compression moulded crystalline polyimide product, wherein the polyimide comprises a first repeat unit derived from pyromellitic dianhydride (PMDA) and a second repeat unit derived from 4,4′-oxodianiline (4,4′-ODA), and wherein the hot isostatically pressed crystalline polyimide product, ram extruded (that may optionally be subsequently hot isostatically pressed) crystalline polyimide product, or hot compression moulded crystalline polyimide product:
does not comprise an encapsulated filler, comprises 0 wt % to 0.5 wt % of an additive relative to the weight of the polyimide, and has a tensile strength of 87.0 MPa or greater; or
comprises 10 wt % to 20 wt % of an encapsulated filler relative to the weight of the polyimide, comprises 0 wt % to 0.5 wt % of an additive relative to the weight of the polyimide, and has a tensile strength of 66.0 MPa or greater; or
comprises 20 wt % to 60 wt % of an encapsulated filler relative to the weight of the polyimide, comprises 0 wt % to 2.0 wt % of an additive relative to the weight of the polyimide, and has a tensile strength of 52.5 MPa or greater; or
comprises 10 wt % to 20 wt % of an encapsulated filler relative to the weight of the polyimide, comprises 5 wt % to 15 wt % of an additive relative to the weight of the polyimide, and has a tensile strength of 49.5 MPa or greater; or
does not comprise an encapsulated filler, comprises 10 wt % to 20 wt % of an additive relative to the weight of the polyimide, and has a tensile strength of 59.0 MPa or greater; or
comprises 20 wt % to 60 wt % of an encapsulated filler relative to the weight of the polyimide, comprises 10 wt % to 20 wt % of an additive relative to the weight of the polyimide, and has a tensile strength of 39.5 MPa or greater.

The present invention also provides an article comprising a formed polyimide product of the invention.

The present invention provides several advantages. The method of the invention enables a reduction in use of volatile organic compounds, enhanced recovery of residual liquid media from the polymerisation process (e.g. greater than 90% solvent recovery), re-use of the fluid after the contacting step, and convenient removal of impurities (e.g. acetic anhydride and phthalic anhydride and their acid derivatives which may be present as residual end capping agents from the polymerisation process). The polyimide with increased SSA of the present invention possesses advantages in that it can better be compacted when processed into a formed product under force, resulting in higher achievable densities for components, improved tensile strength, and improved high temperature mechanical properties. The formed polyimide products of the present invention may have better elevated temperature mechanical properties than VESPEL SP grades and Meldin 7000 grades. The present application provides crystalline formed polyimide products, which may have superior properties to amorphous products and may for example have reduced water absorption than amorphous products.

### DETAILED DESCRIPTION OF THE INVENTION

The present invention provides a method of treating a polyimide, comprising:
providing a polyimide to be treated; and
contacting the polyimide to be treated with a fluid to obtain a treated polyimide;
wherein the polyimide comprises a first repeat unit derived from pyromellitic dianhydride (PMDA) and a second repeat unit derived from 4,4′-oxodianiline (4,4′-ODA);
and wherein the fluid comprises a supercritical fluid, a liquid with a surface tension of 10.0 mN m⁻¹ or less under the conditions of the contacting step, or a mixture thereof.

The polyimide to be treated comprises a first repeat unit derived from PMDA and a second repeat unit derived from 4,4′-ODA. Polyimides comprising a first repeat unit derived from PMDA and a second repeat unit derived from 4,4′-ODA are known in the art and are described in U.S. Pat. Nos. 3,249,588 and 3,179,631, for example.

In general, any polyimide to be treated comprising a first repeat unit derived from PMDA and a second repeat unit derived from 4,4′-ODA is suitable for use as the polyimide to be treated in the methods of the present invention.

The polyimide to be treated may have a number average molecular weight of e.g., 10 to 500 kDa, 100 to 600 kDa, 200 to 700 kDa, 300 to 800 kDa, 400 to 900 kDa, or 500 to 1000 kDa.

The polyimide to be treated may have a weight average molecular weight of e.g., 10 to 500 kDa, 100 to 600 kDa, 200 to 700 kDa, 300 to 800 kDa, 400 to 900 kDa, or 500 to 1000 kDa.

The polyimide to be treated may have a polydispersity index of e.g. 0.8 to 1.0, 0.9 to 1.1, or 1.0 to 1.2.

The relative molar amounts of the PMDA and 4,4′-ODA repeat units in the polyimide to be treated are not particularly limited. Typically the molar ratio of PMDA:4,4′-ODA is in a range of from 1:1.1 to 1.1:1. Preferably, the molar ratio of PMDA:4,4′-ODA is in a range of from 1:1.07 to 1.07:1. More preferably, the molar ratio of PMDA:4,4′-ODA is in a range of from 1:1.05 to 1.05:1. Still more preferably, the molar ratio of PMDA:4,4′-ODA is in a range of from 1:1.03 to 1.03:1. Most preferably the molar ratio of PMDA:4,4′-ODA is in a range of from 1:1.01 to 1.01:1, or about 1:1.

The polyimide to be treated may further comprise additional repeat units besides those derived from PMDA and 4,4′-ODA. Suitable additional repeat units include those derived from dianhydride monomers such as 2,3,6,7-naphthalenetetracarboxylic acid dianhydride, 3,3′,4,4′-diphenyltetracarboxylic acid dianhydride, 1,2,5,6-naphthalenetetracarboxylic acid dianhydride, 2,2′,3,3′-diphenyltetracarboxylic acid dianhydride, 2,2-bis-(3,4-dicarboxyphenyl)-propane dianhydride, bis-(3,4-dicarboxyphenyl)-sulfone dianhydride, bis-(3,4-dicarboxyphenyl)-ether dianhydride, 2,2-bis-(2,3-dicarboxyphenyl)-propane dianhydride, 1,1-bis-(2,3-dicarboxyphenyl)-ethane dianhydride, 1,1-bis-(3,4-dicarboxyphenyl)-ethane dianhydride, bis-(2,3-dicarboxyphenyl)-methane dianhydride, bis-(3,4-dicarboxyphenyl)-methane dianhydride, 3,4,3′,4′-benzophenonetetracarboxylic acid dianhydridex, benzophenonetetracarboxylic acid dianhydride (BTDA) or diphenyltetracarboxylic acid dianhydride (BPDA), or a mixture thereof. Suitable additional repeat units include those derived from 4,4′-diaminodiphenylpropane, 4,4′-diaminodiphenylmethane, 4,4′-diaminodiphenylamine, benzidine, 4,4′-diaminodiphenyl sulfide, 4,4′-diaminodiphenyl sulfone, 3,3′-diaminodiphenyl sulfone, 4,4′-diaminodiphenyl ether, bis-(4-aminophenyl)diethylsilane, bis-(4-aminophenyl)-phenylphosphine oxide, bis-(4-aminophenyl)-N-methylamine, 1,5-diaminonaphthalene, 3,3′-dimethyl-4,4′-diaminobiphenyl, 3,3′-dimethoxybenzidine, 1,4-bis-(p-aminophenoxy)-benzene, 1,3-bis-(p-aminophenoxy)-benzene, m-phenylenediamine (MPD), p-phenylenediamine (PPD), or any mixture thereof.

The polyimide to be treated preferably does not comprise additional repeat units besides those derived from PMDA and 4,4′-ODA. Thus, the polyimide to be treated is preferably a co-polymer of PMDA and 4,4′-ODA. As used herein the term poly(PMDA-co-4,4′-ODA) refers to a co-polymer of PMDA and 4,4′-ODA, which does not comprise additional repeat units besides those derived from PMDA and 4,4′-ODA.

The polyimide to be treated may comprise end capping units, such as units that may be derived from phthalic anhydride or acetic anhydride, preferably from acetic anhydride. Such end capping units are not additional repeat units.

The polyimide to be treated is typically not a gel. The polyimide to be treated is typically not an aerogel.

The polyimide to be treated is typically in powder form. As used herein the term powder refers to any form where the polyimide is present as a plurality of particles and includes, for example, dry powders as well as wet aggregations comprising the polyimide to be treated.

As used herein a wet aggregation comprising the polyimide to be treated typically comprises the polyimide to be treated and liquid media. Said liquid media may comprise liquids used in the preparation of the polyimide to be treated (e.g. liquids used in the preparation methods disclosed in U.S. Pat. Nos. 3,249,588, 3,179,631 and/or 4,755,555 or any combination of such liquid(s)) such as for example solvents, wash liquids, unused reagents (including for example monomers and end capping agents).

When in powder form, the polyimide to be treated typically has a particle size characterised by a volume median diameter (Dv50) of 10 to 80 μm. Preferably, the particle size may be characterised by a Dv50 of 20 to 70 μm. More preferably, the particle size may be characterised by a Dv50 of 25 to 60 μm. As described elsewhere herein, the polyimide to be treated may comprise an encapsulated filler. The typical, preferable, more preferable, still more preferable and most preferable particle sizes described above apply to embodiments where the polyimide to be treated comprises an encapsulated filler and embodiments where the polyimide to be treated does not comprise an encapsulated filler.

The Dv50 values referred to herein are typically as measured by laser diffraction in deionised water in accordance with ISO13320:2009.

The polyimide to be treated may comprise an encapsulated filler. In embodiments where the polyimide to be treated comprises an encapsulated filler, the encapsulated filler is typically graphite.

Particles of the filler encapsulated within the polyimide to be treated typically have a Dv90 of 2.0 to 10.0 μm, preferably 3 to 9 μm, more preferably 4.0 to 8.0 μm, and most preferably 5.0 to 7.0 μm.

The amount of encapsulated filler present in the polyimide to be treated is typically 5 to 60 wt %, such as 10 to 20 wt % or 35 to 45 wt %, preferably 12 to 18 wt % or 37 to 43 wt %, more preferably 14 to 16 wt % or 39 to 41 wt % and most preferably about 15 wt % or about 40 wt %, relative to the weight of the polyimide to be treated.

The polyimide to be treated can be prepared by methods known in the art, for example the methods described in U.S. Pat. Nos. 3,249,588, 3,179,631 and 4,755,555 or by analogy with such known methods.

As used herein the contacting step refers to the step of the method of the present invention in which the polyimide to be treated is contacted with the fluid to obtain a treated polyimide. The term “conditions of the contacting step” typically refers to the temperature and pressure at which the polyimide to be treated is contacted with the fluid.

The contacting step may be carried out following preparation of the polyimide to be treated. Known preparation methods (e.g. methods disclosed in U.S. Pat. Nos. 3,249,588, 3,179,631, and/or 4,755,555) typically include a step of precipitating the polyimide. Subsequent to the step of precipitating the polyimide, the known preparation methods typically include a step of washing the polyimide, a step of drying the polyimide under vacuum and/or a step of heating the polyimide (e.g. to a temperature above 160° C.). At the time of carrying out the contacting step in method of the present invention, the polyimide to be treated has typically not been subjected to a step of drying the polyimide under vacuum and/or a step of heating the polyimide (e.g. to a temperature above 160° C.) for a time sufficient to remove substantially all liquid media from the polyimide to be treated. In this context liquid media refers to liquids used in the preparation of the polyimide to be treated (e.g. liquids used in the preparation methods disclosed in U.S. Pat. Nos. 3,249,588, 3,179,631 and/or 4,755,555 or any combination of such liquid(s)) such as for example solvents, wash liquids, unused reagents (including for example monomers and end capping agents). In this context removal of substantially all liquid media refers to removal of liquid media to the extent that said liquid media are present in an amount of 25.0 wt % or less, 15.0 wt % or less, 10.0 wt % or less, 5.0 wt % or less, e.g 2.5 wt % or less, 1 wt % or less, 0.8 wt % or less, 0.6 wt % or less, 0.4 wt % or less, 0.2 wt % or less, or 0.1 wt % or less, relative to the weight of the polyimide to be treated.

The contacting step may be carried out substantially immediately after the polyimide to be treated has been prepared, or the contacting step may be carried out following an interval after the polyimide to be treated has been prepared. In this context, reference to the polyimide having been prepared may refer to the point at which a precipitation step has been completed, the point at which a washing step has been completed, or the point at which the step of drying the polyimide (e.g. under vacuum conditions) has been completed. In embodiments where the contacting step is carried out following an interval after the polyimide to be treated has been prepared, the interval may for example be 1 year or less, 6 months or less, 4 months or less, 2 months or less, 1 month or less, 2 weeks or less, 1 week or less, 72 hours or less, 48 hours or less, 24 hours or less, 12 hours or less, 6 hours or less, 4 hours or less, 3 hours or less, 2 hours or less, 1 hour or less, 45 minutes or less, 30 minutes or less, 20 minutes or less, 10 minutes or less, or 5 minutes or less. The polyimide to be treated may be in the form of a wet aggregation, as described herein, for the duration of the interval.

The contacting step may be carried out under any suitable conditions, provided that the fluid with which the polyimide to be treated is contacted comprises a supercritical fluid and/or a liquid with the desired low surface tension (e.g. 10.0 mN m⁻¹ or less or as described elsewhere herein) under those conditions. A skilled person will be able to determine suitable conditions for any particular fluid.

The contacting step may for instance be carried out at pressure of 5 to 500 bar, typically 25 to 400 bar, preferably 50 to 300 bar, more preferably 100 to 200 bar, still more preferably 140 to 160 bar or most preferably about 150 bar.

The contacting step may for instance be carried out at a temperature of 20 to 200° C., typically 40 to 150° C., preferably 60 to 100° C., more preferably 70 to 90° C., still more preferably 75 to 85° C. and most preferably about 80° C.

The duration of the contacting step is not particularly limited. A skilled person can readily select an appropriate duration based, for example, on the batch size. The duration of the contacting step may be for instance 1 minute or more, 5 minutes or more, 10 minutes or more, 20 minutes or more, 30 minutes or more, 45 minutes or more, 1 hour or more, 2 hours or more, 3 hours or more, 4 hours or more, or 5 hours or more. The duration of the contacting step may for instance be 24 hours or less, 12 hours or less, 6 hours or less, 4 hours or less, 3 hours or less, 2 hours or less, 1 hour or less, 45 minutes or less, 30 minutes or less, 20 minutes or less, 10 minutes or less, or 5 minutes or less. The duration may be in a range between any applicable combination of upper and lower limits described above.

The contacting step may comprise flowing the fluid over the polyimide to be treated. The contacting step may comprise immersing the polyimide to be treated in the fluid.

In embodiments where the fluid is flowed over the polyimide to be treated, the duration may be determined by the combination of the flow rate of the fluid and the desired amount of fluid to be contacted with the polyimide to be treated. In embodiments where the polyimide to be treated is present in an aggregation comprising polyimide particles and liquid media, the desired amount of fluid is typically determined based on the combined mass of the polyimide particles and liquid media. For example, the ratio of the mass of the fluid with which the polyimide to be treated is contacted, to the combined mass of the polyimide particles and liquid media may typically be in a range of 1:1 to 25:1, preferably 2:1 to 20:1, more preferably 4:1 to 15:1, still more preferably 6:1 to 10:1, most preferably about 8:1. Said liquid media may comprise liquids used in the preparation of the polyimide to be treated (e.g. liquids used in the preparation methods disclosed in U.S. Pat. Nos. 3,249,588, 3,179,631 and/or 4,755,555 or any combination of such liquid(s)) such as for example solvents, wash liquids, unused reagents (including for example monomers and end capping agents).

In embodiments where the fluid is flowed over the polyimide to be treated, the flow rate of the fluid is not particularly limited. A skilled person can readily select an appropriate flow rate based on, for example, the batch size and the desired amount of fluid to be contacted with the polyimide to be treated. The flow rate of the fluid may be for example 0.5 kg of fluid per minute or more, 1 kg of fluid per minute or more, 2 kg of fluid per minute or more, 3 kg of fluid per minute or more, 4 kg of fluid per minute or more, 5 kg of fluid per minute or more, 6 kg of fluid per minute or more, 7 kg of fluid per minute or more, 8 kg of fluid per minute or more, 9 kg of fluid per minute or more, 10 kg of fluid per minute or more, or 25 kg of fluid per minute or more. The flow rate of the fluid may for example be 50 kg of fluid per minute or less, 30 kg of fluid per minute or less, 15 kg of fluid per minute or less, 12 kg of fluid per minute or less, 10 kg of fluid per minute or less, 9 kg of fluid per minute or less, 8 kg of fluid per minute or less, 7 kg of fluid per minute or less, 6 kg of fluid per minute or less, 5 kg of fluid per minute or less, 3 kg of fluid per minute or less, 2 kg of fluid per minute or less, or 1 kg of fluid per minute or less. The flow rate may be in a range between any applicable combination of upper and lower limits described above, e.g. 25 to 50 kg of fluid per minute, and would ultimately be determined by the batch size and/or the size of the plant utilised to perform the extraction.

Apparatus suitable for contacting solids with fluids are known in the art and a skilled person will be able to select an appropriate apparatus. For example, in embodiments where the fluid comprises a supercritical liquid, supercritical extraction apparatus may be used. Suitable supercritical extraction apparatus are commercially available and well known in fields such as decaffeination of coffee and extraction of cannabidiol from cannabis.

“The fluid” referred to herein is the fluid with which the polyimide to be treated is contacted in the contacting step, unless context indicates otherwise. The fluid comprises a supercritical fluid or a low-surface tension liquid. As used herein, the term “low surface tension liquid” refers to a liquid having a surface tension of 10.0 mN m⁻¹ or less under the conditions of the contacting step. As used herein, the term “supercritical fluid” refers to a substance at a temperature and pressure above its critical point, the critical point of a substance being the highest temperature and pressure at which both a gaseous and a liquid phase of the substance can coexist.

The fluid used in the contacting step may comprise a low surface tension liquid. As used herein the term “surface tension” when used to describe a liquid refers to the liquid-air surface tension. The surface tension of a liquid under the conditions of the contacting step may be determined experimentally according to the procedure described by Chen et al.; Measuring Surface Tension of Liquids at High Temperature and Elevated Pressure; J. Chem. Eng. Data 2008, 53, 742-744, or may be calculated empirically by the techniques described by J. R. Brock and R. B. Bird (AICHE Journal 1, 174 (1955)), D. I. Hakim, D. Steinberg, and L. I. Stiel, (Ind. Eng. Chem. Fundam. 10, 174 (1971)), C. Miqueu, D. Broseta, J. Satherley, B. Mendiboure, J. Lachaise, and A. Gracia, (Fluid Phase Equil. 172, 169 (2000)), or Y.-X. Zuo and E. H. Stenby, (Can. J. Chem. Eng. 75, 1130 (1997)).

The low surface tension liquid has a surface tension of 10.0 mN m⁻¹ or less under the conditions of the contacting step, and typically has a surface tension of 8.5 mN m⁻¹ or less under the conditions of the contacting step, preferably 8.5 or less, more preferably 6.0, still more preferably 4.5 or less, even more preferably 2.0 or less, and most preferably 1.0 or less.

When the contacting step is carried out over a range of temperatures and/or pressures, a liquid is considered to have a specific surface tension under the conditions of the contacting step if the liquid has that specific surface tension at a temperature and/or pressure within the range of temperatures and/or pressures over which the contacting step is carried out.

Suitable substances for the supercritical fluid include methane, ethane, ethylene, carbon dioxide, nitrous oxide, and mixtures thereof.

Suitable substances for the low surface tension liquid include methane, ethane, ethylene, carbon dioxide, nitrous oxide, and mixtures thereof.

Typically the fluid comprises supercritical CO₂ and/or low surface tension liquid CO₂. Preferably the fluid comprises supercritical CO₂, i.e. the fluid comprises supercritical CO₂, the temperature of the contacting step is 31.0° C. or more, and the pressure of the contacting step is 73.8 bar or more (i.e. the contacting step is carried out above the critical point of CO₂). More preferably, the fluid comprises supercritical CO₂ and the conditions of the contacting step comprise a temperature of 60 to 100° C. and a pressure of 100 to 200 bar. Still more preferably the fluid comprises supercritical CO₂ and the conditions of the contacting step comprise a temperature of 70 to 90° C. and a pressure of 140 to 160 bar. Most preferably the fluid comprises supercritical CO₂ and the conditions of the contacting step comprise a temperature of about 80° C. and a pressure of about 150 bar.

When the fluid comprises low surface tension liquid CO₂, the conditions of the contacting step typically comprise a temperature of −40.0° C. or more and a pressure of 10.0 bar or more, e.g. a temperature of −40.0° C. or more and less than 31.0° C., and a pressure of 10.0 bar or more and less than 73.8 bar.

In addition to the supercritical fluid and/or low surface tension liquid, the fluid may further comprise a co-solvent. Easily removed by the process or by subsequent drying. Suitable co-solvents may include ethanol, isopropyl alcohol, acetone, and toluene.

The polyimide is typically chemically unchanged by the contacting step. Thus, the chemical composition of the treated polyimide is typically the same as that of the polyimide to be treated, as described above.

The physical properties of the treated polyimide are typically improved as a result of the contacting step. The BET specific surface area of the treated polyimide is typically greater than that of the polyimide to be treated. The BET specific surface area of the treated polyimide is typically greater than that of polyimide washed by solvents previously known in the art.

BET specific surface areas referred to herein are typically determined according to ISO 9211:2010 using multi-point determination with N₂ Technical X47S as the adsorptive with a purity of 99.999%, impurities present as H₂O<3 ppm, impurities present as O₂<5 ppm.

Without wishing to be bound by theory, it is believed that the use of a supercritical fluid and/or low surface tension liquid will interact with pores within the polyimide to be treated to increase the BET specific surface area, and that an increased BET specific surface area results in increased tensile strength when the polyimide is formed into a product. The fluid used in the present invention is thought to be much more effective at extracting residual liquid media from the pores and nanofluidic channels of the polyimide following the polyimide production process.

Preparation of the polyimide typically comprises polymerising a diamine and a dianhydride to form a poly(amide-acid), followed by condensation of the groups in the polyamide-acid to form a polyimide. Although reference is generally made herein to contacting a polyimide with the fluid, embodiments of the invention are disclosed herein in which the polyamide-acid (e.g. solid polyamide-acid such as in the form of a precipitate) is contacted with the fluid, and subsequently converted to a polyimide. Such embodiments are typically as described herein with respect to embodiments in which the polyimide is contacted with the fluid, with the exception that the contacting step comprises contacting the polyamide-acid (e.g. solid polyamide-acid such as in the form of a precipitate) to be treated with the fluid to obtain a treated polyamide-acid, and that the method further comprises a step of converting the treated polyamide acid into a treated polyimide. Thus, in such embodiments, the present invention provides a method of treating a polyimide, comprising: providing a polyamide-acid to be treated; contacting the polyamide-acid to be treated with a fluid to obtain a treated polyamide-acid; and converting the treated polyamide acid into a treated polyimide; wherein the polyimide comprises a first repeat unit derived from pyromellitic dianhydride (PMDA) and a second repeat unit derived from 4,4′-oxodianiline (4,4′-ODA); and wherein the fluid comprises a supercritical fluid, a liquid with a surface tension of 10.0 mN m⁻¹ or less under the conditions of the contacting step, or a mixture thereof.

Conversion of the polyamide-acid into a polyimide can be carried out by known methods, e.g. as disclosed in U.S. Pat. Nos. 3,179,631 and/or 4,755,555, for example by heat treatment at a temperature of 160° C. or higher, e.g. at a temperature in the range from 160° C. to 200° C.

The treated polyimide is typically in powder form. The particle size of the treated polyimide is typically as described above with reference to the polyimide to be treated.

The method of the present invention may comprise an optional further step of mixing the treated polyimide with an additive to obtain a polyimide mixture. The mixing may comprise dry blending with an additive (e.g. blending with an additive after drying the treated polyimide). Suitable additives include moulding additives and lubricants. For example, PTFE may be mixed with the treated polyimide in an amount of from 0.1 wt % to 15 wt % relative to the weight of the polyimide to be treated. PTFE is typically present as a moulding additive and/or a lubricant. In another example, MoS₂ may be mixed with the treated polyimide powder in an amount of typically from 0.1 wt % to 15 wt % relative to the weight of the polyimide to be treated. MoS₂ is typically present as a lubricant.

The method of the present invention may comprise an optional further step of forming the treated polyimide and/or polyimide mixture to obtain a formed polyimide product.

Suitable forming techniques may include direct forming, hot isostatic pressing, hot compression moulding, and ram extrusion (optionally with subsequent Hot Isostatic Pressing).

Direct forming, hot isostatic pressing, hot compression moulding, and ram extrusion techniques are known in the art and a skilled person will be able to carry out a suitable technique to obtain a desired formed product, for example in accordance with the techniques described in U.S. Pat. Nos. 3,413,394, 4,238,538, and Canadian Pat 890515.

For example, direct formed products may be obtained by direct forming at a pressure of 10,000 to 500,000 psi (e.g. 50,000 to 200,000 psi, 75,000 to 125,000 psi or about 100,000 psi), followed by firing at 200 to 600° C. (e.g. 250 to 550° C., 300 to 500° C., 350 to 450° C. or about 400° C.).

Hot compression moulded products may be formed, for example, by hot compression moulding at high temperature and pressure for 1 hour or more, 2 hours or more, 3 hours or more, 4 hours or more, or 5 hours or more, 24 hours or less, 12 hours or less, 6 hours or less, 4 hours or less, 3 hours or less, 2 hours or less, or any applicable combination of upper and lower limits described above. Pressure for hot compression moulding may be in a range of 10,000 to 500,000 psi (e.g. 50,000 to 200,000 psi, 75,000 to 125,000 psi or about 100,000 psi). Temperature for hot compression moulding may be in a range of 200 to 600° C. (e.g. 250 to 550° C., 300 to 500° C., 350 to 450° C. or about 400° C.). The hot compression moulding step may be followed by a machining step (e.g. to obtain a precise size and/or shape). Suitable techniques are described in U.S. Pat. No. 3,413,394.

Ram extruded (that may optionally be subsequently hot isostatically pressed) products may be formed, for example, by ram extruding in a die having (a) a compaction zone, followed by (b) a back pressure zone, followed by (c) a relief zone, and in particular carrying out the steps of: (1) compacting the polyimide in the compaction zone, at a temperature in a range of 20 to 600° C. (e.g. 250 to 550° C., 300 to 500° C., 350 to 450° C. or about 400° C.), while simultaneously (2) providing back pressure on the polyimide at the exit of the compaction zone by moving the compacted polyimide through the back pressure zone, and, thereafter, (3) relieving the pressure on the polyimide in the relief zone to control the rate of elastic recovery thereof. The process typically resulting in a radial recovery of the compacted polyimide of about 3 to 5 percent as such compacted polyimide is moved through the relief zone to form the formed product. Suitable techniques are described in U.S. Pat. No. 4,238,538.

The ram extruded crystalline polyimide product of the present invention includes ram extruded crystalline polyimide products which have been hot isostatically pressed subsequent to ram extrusion, and also includes ram extruded crystalline polyimide products which have not been hot isostatically pressed subsequent to ram extrusion.

Hot isostatic pressed products may be formed, for example, by compacting the polyimide into a preform, and then compacting the preform isostatically in an inert molten metal at high pressure to its desired density while sintering it, with or without heat treatment between the two compacting steps. The inert molten metal may for example be molten lead. The pressure of the isostatic compacting step may be in a range of 1,000 to 50,000 psi (e.g. 5,000 to 20,000 psi, 7,500 to 12,500 psi or about 10,000 psi). The temperature of the sintering and the optional heat treatment steps may be in a range of 200 to 600° C. (e.g. 250 to 550° C., 300 to 500° C., 350 to 450° C. or about 400° C.). Suitable techniques are described in CA890515.

The treated polyimide may be dried prior to forming into a formed polyimide product, e.g. at a temperature of 100° C. to 200° C. Drying may take place in air, in an inert atmosphere (e.g. N₂) or under vacuum.

The present invention also provides a polyimide.

The polyimide of the invention may be a treated polyimide obtainable by the method of the invention.

The polyimide of the present invention may be a polyimide having a BET specific surface area greater than 100 m² g⁻¹, wherein the polyimide comprises a first repeat unit derived from pyromellitic dianhydride (PMDA) and a second repeat unit derived from 4,4′-oxodianiline (4,4′-ODA), and wherein the polyimide does not comprise a encapsulated filler or comprises an encapsulated filler in an amount of 20 wt % or less (e.g. 16 wt % or less) relative to the weight of the polyimide.

The polyimide of the present invention may be a polyimide having a BET specific surface area greater than 70 m² g⁻¹ (e.g. 85 m² g⁻¹ or greater), wherein the polyimide comprises a first repeat unit derived from pyromellitic dianhydride (PMDA) and a second repeat unit derived from 4,4′-oxodianiline (4,4′-ODA), and wherein the treated polyimide comprises an encapsulated filler in an amount of 20 wt % to 60 wt % (e.g. 16 wt % to 60 wt %) relative to the weight of the polyimide.

The polyimide of the present invention may be a powder, e.g. dry powder. When in powder form (e.g. dry powder form), the polyimide may have a BET specific surface area greater than 100 m² g⁻¹, for example in embodiments where the polyimide does not comprise an encapsulated filler. Typically, and particularly in embodiments where the polyimide does not comprise an encapsulated filler, the polyimide of the present invention has a BET specific surface area of 110 m² g⁻¹ or more, preferably 120 m² g⁻¹ or more, more preferably 130 m² g⁻¹ or more, still more preferably 140 m² g⁻¹ or more, most preferably 150 m² g⁻¹ or more.

In embodiments where the polyimide comprises an encapsulated filler, e.g. in an amount of 10 wt % to 20 wt % relative to the weight of the polyimide, the polyimide of the present invention typically has a BET specific surface area of 100 m² g⁻¹ or more, preferably 105 m² g⁻¹ or more, more preferably 110 m² g⁻¹ or more, still more preferably 115 m² g⁻¹ or more.

In embodiments where the polyimide comprises an encapsulated filler, e.g. in an amount of 20 wt % to 60 wt % relative to the weight of the polyimide, the polyimide of the present invention typically has a BET specific surface area of 70 m² g⁻¹ or more, preferably 75 m² g⁻¹ or more, more preferably 80 m² g⁻¹ or more, still more preferably 85 m² g⁻¹ or more, most preferably 90 m² g⁻¹ or more.

The presence of an encapsulated filler within the polyimide resin typically reduces the BET specific surface area of the polyimide compared to a polyimide which does not comprise an encapsulated filler. However the BET specific surface area of a polyimide according to the present invention which comprises an encapsulated filler will typically be greater than was achievable for the same amount of encapsulated filer prior to the present invention.

The polyimide may have a BET specific surface area of 500 m² g⁻¹ or less, e.g. 400 m² g⁻¹ or less, 300 m² g⁻¹ or less, 200 m² g⁻¹ or less, 150 m² g⁻¹ or less, or 100 m² g⁻¹ or less.

BET specific surface areas referred to herein are typically determined according to ISO 9277:2010 using multi-point determination with N₂ Technical X47S as the adsorptive with a purity of 99.999%, impurities present as H₂O<3 ppm, impurities present as O₂<5 ppm.

The polyimide of the present invention may be in powder form, and typically has a particle size characterised by a volume median diameter (Dv50) of 10 to 80 μm. Preferably, the particle size may be characterised by a Dv50 of 20 to 70 μm. More preferably, the particle size may be characterised by a Dv50 of 25 to 60 μm.

In embodiments where the polyimide does not comprise an encapsulated filler, the polyimide of the present invention may have a particle size (Dv50) of 10 to 80 μm, preferably 20 to 70 μm, more preferably 35 to 60 μm still more preferably 45 to 50 μm, most preferably about 47.5 μm.

In embodiments where the polyimide comprises an encapsulated filler in an amount of 10 wt % to 20 wt % relative to the weight of the polyimide, the polyimide of the present invention may have a particle size (Dv50) of 10 to 80 μm, preferably 20 to 70 μm, more preferably 25 to 50 μm, still more preferably 35 to 40 μm, and most preferably about 38 μm.

In embodiments where the polyimide comprises an encapsulated filler in an amount of 20 wt % to 60 wt % relative to the weight of the polyimide, the polyimide of the present invention may have a particle size (Dv50) of 10 to 80 μm, preferably 20 to 50 μm, more preferably 25 to 45 μm.

The polyimide of the present invention may have a BET specific surface area as described above and a particle size (Dv50) as descried above. Combinations of all the BET specific surface areas described above with any of the Dv50 particle sizes described above are disclosed. For example, particularly in embodiments where the polyimide does not comprise an encapsulated filler, the polyimide of the present invention may have a particle size (Dv50) of 10 to 80 μm and a BET specific surface area greater than 100 m² g⁻¹ (e.g. 100 to 500 m² g⁻¹, 100 to 400 m² g⁻¹, 100 to 300 m² g⁻¹, 100 to 200 m² g⁻¹); a particle size (Dv50) of 20 to 70 μm and a BET specific surface area of 110 m² g⁻¹ or more (e.g. 110 to 500 m² g⁻¹, 110 to 400 m² g⁻¹, 110 to 300 m² g⁻¹, 110 to 200 m² g⁻¹); a particle size (Dv50) of 35 to 60 μm and a BET specific surface area of 120 m² g⁻¹ or more (e.g. 120 to 500 m² g⁻¹, 120 to 400 m² g⁻¹, 120 to 300 m² g⁻¹, 120 to 200 m² g⁻¹); a particle size (Dv50) of 45 to 50 μm and a BET specific surface area of 130 m² g⁻¹ or more (e.g. 130 to 500 m² g⁻¹, 130 to 400 m² g⁻¹, 130 to 300 m² g⁻¹, 130 to 200 m² g⁻¹); or a particle size (Dv50) of about 47.5 μm and a BET specific surface area of 130 m² g⁻¹ or more (e.g. 130 to 500 m² g⁻¹, 130 to 400 m² g⁻¹, 130 to 300 m² g⁻¹, 130 to 200 m² g⁻¹).

In embodiments where the polyimide comprises an encapsulated filler in an amount of 10 wt % to 20 wt % relative to the weight of the polyimide, the polyimide of the present invention may have a particle size (Dv50) of 10 to 80 μm and a BET specific surface area greater than 100 m² g⁻¹ (e.g. 100 to 450 m² g⁻¹, 100 to 350 m² g⁻¹, 100 to 250 m² g⁻¹, 100 to 150 m² g⁻¹); a particle size (Dv50) of 20 to 70 μm and a BET specific surface area of 105 m² g⁻¹ or more (e.g. 105 to 450 m² g⁻¹, 105 to 350 m² g⁻¹, 105 to 250 m² g⁻¹, 105 to 150 m² g⁻¹); a particle size (Dv50) of 25 to 50 μm and a BET specific surface area of 110 m² g⁻¹ or more (e.g. 110 to 450 m² g⁻¹, 110 to 350 m² g⁻¹, 110 to 250 m² g⁻¹, 110 to 150 m² g⁻¹); a particle size (Dv50) of 35 to 40 μm and a BET specific surface area of 115 m² g⁻¹ or more (e.g. 115 to 450 m² g⁻¹, 115 to 350 m² g⁻¹, 115 to 250 m² g⁻¹, 115 to 150 m² g⁻¹); or a particle size (Dv50) of about 38 μm and a BET specific surface area of 115 m² g⁻¹ or more (e.g. 115 to 450 m² g⁻¹, 115 to 350 m² g⁻¹, 115 to 250 m² g⁻¹, 115 to 150 m² g⁻¹).

In embodiments where the polyimide comprises an encapsulated filler in an amount of 20 wt % to 60 wt % relative to the weight of the polyimide, the polyimide of the present invention may have a particle size (Dv50) of 10 to 80 μm and a BET specific surface area greater than 70 m² g⁻¹ (e.g. 70 to 200 m² g⁻¹, 70 to 150 m² g⁻¹, 70 to 100 m² g⁻¹, 85 to 200 m² g⁻¹, 85 to 150 m² g⁻¹, 85 to 100 m² g⁻¹); a particle size (Dv50) of 20 to 50 μm and a BET specific surface area of 75 m² g⁻¹ or more (e.g. 75 to 200 m² g⁻¹, 75 to 150 m² g⁻¹, 75 to 100 m² g⁻¹, 85 to 200 m² g⁻¹, 85 to 150 m² g⁻¹, 85 to 100 m² g⁻¹); a particle size (Dv50) of 25 to 40 μm and a BET specific surface area of 80 m² g⁻¹ or more (e.g. 80 to 200 m² g⁻¹, 80 to 150 m² g⁻¹, 80 to 100 m² g⁻¹); a particle size (Dv50) of 25 to 40 μm and a BET specific surface area of 85 m² g⁻¹ or more (e.g. 85 to 200 m² g⁻¹, 85 to 150 m² g⁻¹, 85 to 100 m² g⁻¹); or a particle size (Dv50) of 25 to 40 μm and a BET specific surface area of 90 m² g⁻¹ or more (e.g. 90 to 200 m² g⁻¹, 90 to 150 m² g⁻¹, 90 to 100 m² g⁻¹).

The polyimide of the present invention may comprise an encapsulated filler. The encapsulated filler in the polyimide of the present invention is typically as described elsewhere herein with reference to the method of the present invention. The typical, preferable, more preferable, still more preferable and most preferable particle sizes described above apply to embodiments where the polyimide of the present invention comprises an encapsulated filler and embodiments where the polyimide to be treated does not comprise an encapsulated filler. The Dv50 values referred to herein are typically as measured by laser diffraction in deionised water in accordance with ISO13320:2009.

The polyimide of the present invention is typically a crystalline polyimide. As used herein the term crystalline refers to a polyimide with a crystallinity index of 15.0 or greater in embodiments where the polyimide does not comprise an encapsulated filler and embodiments where the polyimide comprises an encapsulated filler in an amount of up to 20 wt % relative to the weight of the polyimide (e.g. 10 wt % to 20 wt % relative to the weight of the polyimide), and to a polyimide with a crystallinity index of 17.0 or greater in embodiments where the polyimide comprises an encapsulated filler in an amount of 20 wt % or more relative to the weight of the polyimide (e.g. 20 wt % to 60 wt % relative to the weight of the polyimide).

In embodiments where the polyimide does not comprise an encapsulated filler and embodiments where the polyimide comprises an encapsulated filler in an amount of 10 wt % to 20 wt % relative to the weight of the polyimide, the crystallinity index of the polyimide of the present invention is typically 15.0 or greater, e.g. 15.5 or greater, 16.0 or greater, 16.5 or greater, 17.0 or greater, 17.5 or greater, 18.0 or greater, 20.0 or greater, 22.0 or greater, 24.0 or greater, 26.0 or greater, 28.0 or greater, or 30.0 or greater.

In embodiments where the polyimide comprises an encapsulated filler in an amount of 20 wt % to 60 wt % relative to the weight of the polyimide, the crystallinity index of the polyimide of the present invention is typically 17.0 or greater, e.g. 17.5 or greater, 18.0 or greater, 18.5 or greater, 19.0 or greater, 19.5 or greater, 20.0 or greater, 22.0 or greater, 24.0 or greater, 26.0 or greater, 28.0 or greater, 30.0 or greater.

The crystallinity index of the polyimide of the present invention may be 90.0 or less, e.g. 80.0 or less, 70.0 or less, 60.0 or less, or 50.0 or less.

The crystallinity index of the polyimide of the present invention is typically from 17.0 to 90.0, preferably 20.0 to 80.0, more preferably 25.0 to 70.0, still more preferably 30.0 to 60.0.

The crystallinity index of the polyimide of the present invention is typically measured by differential scanning calorimetry (DSC). Suitable equipment which may be used, for example, is a DSC 1 (Mettler Toledo) with a 70 μl platinum pan with pierced lid. The sample may be for example a 5 mg sample and may be heated from 40° C. to 700° C. at a heating rate of 10° C./min. The degree of crystallinity, a, can then be estimated from the peak area:

$$α = \frac{Δ h}{Δ {h}_{c}} \cdot 100 \%$$

where Δh is the specific enthalpy of fusion (in J/g) of the sample determined from the peak area, and Δh_{c} is the enthalpy of fusion of a 100% crystalline material. The heat of fusion of the polyimide may be obtained from literature sources, such as “Handbook of Polymers” By George Wypych (2^{nd} edition, 2016, ChemTec Publishing). For poly(PMDA-co-4,4′-ODA) a heat of fusion of 139 J/g may be used.

The present invention also provides a formed polyimide product.

The formed polyimide product of the present invention may be obtainable by methods of the present invention which comprise a step of forming the treated polyimide or polyimide mixture to obtain a formed polyimide product.

The formed polyimide product of the present invention may be a direct formed crystalline polyimide product wherein the polyimide comprises a first repeat unit derived from pyromellitic dianhydride (PMDA) and a second repeat unit derived from 4,4′-oxodianiline (4,4′-ODA), and wherein the direct formed crystalline polyimide product:
does not comprise an encapsulated filler, comprises 0 wt % to 0.5 wt % of an additive relative to the weight of the polyimide, and has a tensile strength of 80.0 MPa or greater (e.g. 85.0 MPa or greater, 90.0 MPa or greater, 95.0 MPa or greater or 100.0 MPa or greater); or
comprises 10 wt % to 20 wt % of an encapsulated filler relative to the weight of the polyimide, comprises 0 wt % to 0.5 wt % of an additive relative to the weight of the polyimide, and has a tensile strength of 63.0 MPa or greater (e.g. 69.0 MPa or greater, 74.0 MPa or greater, 79.0 MPa or greater, 84.0 MPa or greater or 89.0 MPa or greater); or
comprises 20 wt % to 60 wt % of an encapsulated filler relative to the weight of the polyimide, comprises 0 wt % to 2.0 wt % of an additive relative to the weight of the polyimide, and has a tensile strength of 50.0 MPa or greater (e.g. 55.0 MPa or greater, 60.0 MPa or greater, 65.0 MPa or greater, 70.0 MPa or greater or 75.0 MPa or greater); or
comprises 10 wt % to 20 wt % of an encapsulated filler relative to the weight of the polyimide, comprises 5 wt % to 15 wt % of an additive relative to the weight of the polyimide, and has a tensile strength of 52.5 MPa or greater (e.g. 57.5 MPa or greater, 62.5 MPa or greater, 67.5 MPa or greater or 72.5 MPa or greater); or
comprises 20 wt % to 60 wt % of an encapsulated filler relative to the weight of the polyimide, comprises 10 wt % to 20 wt % of an additive relative to the weight of the polyimide, and has a tensile strength of 39.5 MPa or greater (e.g. 44.5 MPa or greater, 49.5 MPa or greater, 54.5 MPa or greater or 59.5 MPa or greater).

The formed polyimide product of the present invention may be a direct formed crystalline polyimide product having a tensile strength of 80.0 MPa or greater, wherein the direct formed polyimide product does not comprise an encapsulated filler, and wherein the polyimide comprises a first repeat unit derived from pyromellitic dianhydride (PMDA) and a second repeat unit derived from 4,4′-oxodianiline (4,4′-ODA). Embodiments in which the direct formed polyimide product does not comprise an encapsulated filler may comprise an additive, for example 0.5 wt % or less PTFE relative to the weight of the polyimide. Such additives may aid mould release during the moulding activities with the resin.

The formed polyimide product of the present invention may be a direct formed crystalline polyimide product having a tensile strength of 63.0 MPa or greater (e.g. 69 MPa or greater), wherein the direct formed polyimide product comprises an encapsulated filler (e.g. 15 wt %±1.0 wt % graphite relative to the weight of the polyimide), and wherein the polyimide comprises a first repeat unit derived from pyromellitic dianhydride (PMDA) and a second repeat unit derived from 4,4′-oxodianiline (4,4′-ODA). Embodiments in which the direct formed polyimide product comprises an encapsulated filler (e.g. 15 wt %±1.0 wt % graphite relative to the weight of the polyimide) may comprise an additive, for example 0.5 wt % or less PTFE relative to the weight of the polyimide. Such additives may aid mould release during the moulding activities with the resin.

The formed polyimide product of the present invention may be a direct formed crystalline polyimide product having a tensile strength of 50.0 MPa or greater (e.g. 55 MPa or greater), wherein the direct formed polyimide product comprises an encapsulated filler (e.g. 40 wt %±5.0 wt % graphite relative to the weight of the polyimide), and wherein the polyimide comprises a first repeat unit derived from pyromellitic dianhydride (PMDA) and a second repeat unit derived from 4,4′-oxodianiline (4,4′-ODA). Embodiments in which the direct formed polyimide product comprises an encapsulated filler (e.g. 40 wt %±5.0 wt % graphite relative to the weight of the polyimide) may comprise an additive, for example 2.0 wt % or less PTFE relative to the weight of the polyimide. Such additives may aid mould release during the moulding activities with the resin.

The formed polyimide product of the present invention may be a direct formed crystalline polyimide product having a tensile strength of 52.5 MPa or greater, wherein the direct formed polyimide product comprises an encapsulated filler (e.g. 15 wt %±3.0 wt % graphite relative to the weight of the polyimide) and an additive (e.g. 10 wt % 1.0 wt % PTFE relative to the weight of the polyimide), and wherein the polyimide comprises a first repeat unit derived from pyromellitic dianhydride (PMDA) and a second repeat unit derived from 4,4′-oxodianiline (4,4′-ODA).

The formed polyimide product of the present invention may be a direct formed crystalline polyimide product having a tensile strength of 39.5 MPa or greater, wherein the direct formed polyimide product comprises an encapsulated filler (e.g. 40 wt %±5.0 wt % graphite relative to the weight of the polyimide) and an additive (e.g. 15 wt %±1.0 wt % PTFE relative to the weight of the polyimide), and wherein the polyimide comprises a first repeat unit derived from pyromellitic dianhydride (PMDA) and a second repeat unit derived from 4,4′-oxodianiline (4,4′-ODA).

The formed polyimide product of the present invention may be a hot isostatically pressed crystalline polyimide product, ram extruded (that may optionally be subsequently hot isostatically pressed) crystalline polyimide product, or hot compression moulded crystalline polyimide product, wherein the polyimide comprises a first repeat unit derived from pyromellitic dianhydride (PMDA) and a second repeat unit derived from 4,4′-oxodianiline (4,4′-ODA), and wherein the hot isostatically pressed crystalline polyimide product, ram extruded (that may optionally be subsequently hot isostatically pressed) crystalline polyimide product, or hot compression moulded crystalline polyimide product:
does not comprise an encapsulated filler, comprises 0 wt % to 0.5 wt % of an additive relative to the weight of the polyimide, and has a tensile strength of 87.0 MPa or greater (e.g. 92.0 MPa or greater, 97.0 MPa or greater, 102.0 MPa or greater or 107.0 MPa or greater); or
comprises 10 wt % to 20 wt % of an encapsulated filler relative to the weight of the polyimide, comprises 0 wt % to 0.5 wt % of an additive relative to the weight of the polyimide, and has a tensile strength of 66.0 MPa or greater (e.g. 71.0 MPa or greater, 76.0 MPa or greater, 81.0 MPa or greater or 86.0 MPa or greater); or
comprises 20 wt % to 60 wt % of an encapsulated filler relative to the weight of the polyimide, comprises 0 wt % to 2.0 wt % of an additive relative to the weight of the polyimide, and has a tensile strength of 52.5 MPa or greater (e.g. 57.5 MPa or greater, 62.5 MPa or greater, 67.5 MPa or greater or 72.5 MPa or greater); or
comprises 10 wt % to 20 wt % of an encapsulated filler relative to the weight of the polyimide, comprises 5 wt % to 15 wt % of an additive relative to the weight of the polyimide, and has a tensile strength of 49.5 MPa or greater (e.g. 54.5 MPa or greater, 59.5 MPa or greater, 64.5 MPa or greater or 69.5 MPa or greater); or
does not comprise an encapsulated filler, comprises 10 wt % to 20 wt % of an additive relative to the weight of the polyimide, and has a tensile strength of 59.0 MPa or greater (e.g. 64.0 MPa or greater, 69.0 MPa or greater, 74.0 MPa or greater or 79.0 MPa or greater); or
comprises 20 wt % to 60 wt % of an encapsulated filler relative to the weight of the polyimide, comprises 10 wt % to 20 wt % of an additive relative to the weight of the polyimide, and has a tensile strength of 39.5 MPa or greater (e.g. 44.5 MPa or greater, 49.5 MPa or greater, 54.5 MPa or greater or 59.5 MPa or greater).

The formed polyimide product of the present invention may be a hot isostatically pressed crystalline polyimide product, a ram extruded (that may optionally be subsequently hot isostatically pressed) crystalline polyimide product, or a hot compression moulded crystalline polyimide product, said formed polyimide product having a tensile strength of 87.0 MPa or greater, wherein the formed polyimide product does not comprise an encapsulated filler, and wherein the polyimide comprises a first repeat unit derived from pyromellitic dianhydride (PMDA) and a second repeat unit derived from 4,4′-oxodianiline (4,4′-ODA). Embodiments in which the hot isostatically pressed polyimide product, ram extruded (that may optionally be subsequently hot isostatically pressed) polyimide product, or hot compression moulded polyimide product does not comprise an encapsulated filler may comprise an additive, for example 0.5 wt % or less PTFE relative to the weight of the polyimide. Such additives may aid mould release during the moulding activities with the resin.

The formed polyimide product of the present invention may be a hot isostatically pressed crystalline polyimide product, a ram extruded (that may optionally be subsequently hot isostatically pressed) crystalline polyimide product, or a hot compression moulded crystalline polyimide product, said formed polyimide product having a tensile strength of 66.0 MPa or greater, wherein said formed polyimide product comprises an encapsulated filler (e.g. 15 wt %±1.0 wt % graphite relative to the weight of the polyimide), and wherein the polyimide comprises a first repeat unit derived from pyromellitic dianhydride (PMDA) and a second repeat unit derived from 4,4′-oxodianiline (4,4′-ODA). Embodiments in which the hot isostatically pressed crystalline polyimide product, ram extruded (that may optionally be subsequently hot isostatically pressed) crystalline polyimide product, or hot compression moulded crystalline polyimide product comprises an encapsulated filler (e.g. 15 wt %±1.0 wt % graphite relative to the weight of the polyimide) may comprise an additive, for example 0.5 wt % or less PTFE relative to the weight of the polyimide. Such additives may aid mould release during the moulding activities with the resin.

The formed polyimide product of the present invention may be a hot isostatically pressed crystalline polyimide product, a ram extruded (that may optionally be subsequently hot isostatically pressed) crystalline polyimide product, or a hot compression moulded crystalline polyimide product, said formed polyimide product having a tensile strength of 52.5 MPa or greater, wherein said formed polyimide product comprises an encapsulated filler (e.g. 40 wt %±5.0 wt % graphite relative to the weight of the polyimide), and wherein the polyimide comprises a first repeat unit derived from pyromellitic dianhydride (PMDA) and a second repeat unit derived from 4,4′-oxodianiline (4,4′-ODA). Embodiments in which the hot isostatically pressed crystalline polyimide product, ram extruded (that may optionally be subsequently hot isostatically pressed) crystalline polyimide product, or hot compression moulded crystalline polyimide product comprises an encapsulated filler (e.g. 40 wt % 5.0 wt % graphite relative to the weight of the polyimide) may comprise an additive, for example 2.0 wt % or less PTFE relative to the weight of the polyimide. Such additives may aid mould release during the moulding activities with the resin.

The formed polyimide product of the present invention may be a hot isostatically pressed crystalline polyimide product, a ram extruded (that may optionally be subsequently hot isostatically pressed) crystalline polyimide product, or a hot compression moulded crystalline polyimide product, said formed polyimide product having a tensile strength of 49.5 MPa or greater, wherein said formed polyimide product comprises an encapsulated filler (e.g. 15 wt %±3.0 wt % graphite relative to the weight of the polyimide) and an additive (e.g. 10 wt %±1.5 wt % PTFE relative to the weight of the polyimide), and wherein the polyimide comprises a first repeat unit derived from pyromellitic dianhydride (PMDA) and a second repeat unit derived from 4,4′-oxodianiline (4,4′-ODA).

The formed polyimide product of the present invention may be a hot isostatically pressed crystalline polyimide product, a ram extruded (that may optionally be subsequently hot isostatically pressed) crystalline polyimide product, or a hot compression moulded crystalline polyimide product, said formed polyimide product having a tensile strength of 59.0 MPa or greater, wherein said formed polyimide product does not comprise an encapsulated filler and comprises an additive (e.g. 15 wt %±1.5 wt % molybdenum disulphide relative to the weight of the polyimide), and wherein the polyimide comprises a first repeat unit derived from pyromellitic dianhydride (PMDA) and a second repeat unit derived from 4,4′-oxodianiline (4,4′-ODA).

The formed polyimide product of the present invention may be a hot isostatically pressed crystalline polyimide product, a ram extruded (that may optionally be subsequently hot isostatically pressed) crystalline polyimide product, or a hot compression moulded crystalline polyimide product, said formed polyimide product having a tensile strength of 39.5 MPa or greater, wherein said formed polyimide product comprises an encapsulated filler (e.g. 40 wt %±5.0 wt % graphite relative to the weight of the polyimide) and an additive (e.g. 15 wt %±1.0 wt % PTFE relative to the weight of the polyimide), and wherein the polyimide comprises a first repeat unit derived from pyromellitic dianhydride (PMDA) and a second repeat unit derived from 4,4′-oxodianiline (4,4′-ODA).

The tensile strength of a formed polyimide product, as used herein, is as determined by ASTM D1708 based on a 2.5 mm thick test specimen with a test speed of 1 mm per minute. Unless otherwise specified, tensile strengths are as measured at 23° C.

The formed polyimide product of the present invention comprises a polyimide which comprise a first repeat unit derived from pyromellitic dianhydride (PMDA) and a second repeat unit derived from 4,4′-oxodianiline (4,4′-ODA). The composition of the polyimide comprised in the formed polyimide product of the present invention is typically as described above with reference to the polyimide to be treated and/or treated polyimide of the methods of the present invention.

The formed polyimide product of the present invention may comprise an encapsulated filler. In embodiments where the formed polyimide product comprises an encapsulated filler, the encapsulated filler is typically graphite. Particles of the encapsulated filler comprised in the formed polyimide product typically have a Dv90 of 2.0 to 10.0 μm, preferably 3 to 9 μm, more preferably 4.0 to 8.0 μm, and most preferably 5.0 to 7.0 μm. The amount of encapsulated filler present in the formed polyimide product is typically 5 to 60 wt %, such as 10 to 20 wt % or 35 to 45 wt %, preferably 12 to 18 wt % or 37 to 43 wt %, more preferably 14 to 16 wt % or 39 t 41 wt % and most preferably about 15 wt % or about 40 wt %, relative to the weight of the formed polyimide product.

The formed polyimide product of the present invention may comprise an additive. Suitable additives include moulding additives and lubricants, such as PTFE and MoS₂. For example, the formed polyimide product may comprise PTFE in an amount of from 0.1 wt % to 15 wt % relative to the weight of the formed polyimide product. PTFE is typically present as a moulding additive and/or a lubricant. In another example, MoS₂ may be mixed with the treated polyimide powder in an amount of typically from 0.1 wt % to 15 wt % relative to the weight of the formed polyimide product. MoS₂ is typically present as a lubricant.

The direct formed polyimide product of the present invention may have a tensile strength of 80.0 MPa or more and a specific gravity of 1.40 or less. Typically, in such embodiments, the formed polyimide product does not comprise a filler (e.g. does not comprise graphite).

The direct formed polyimide product of the present invention may have a tensile strength of 70.0 MPa or more and a specific gravity of 1.50 or less. Typically, in such embodiments, the formed polyimide product does comprise a filler as described above (e.g. comprises 15 wt %±1.0 wt % graphite relative to the weight of the polyimide).

The direct formed polyimide product of the present invention may have a tensile strength of 40.0 MPa or more at 260° C., e.g. 41.0 MPa or more at 260° C., 42.0 MPa or more at 260° C., or 43.0 MPa or more at 260° C., 44.0 MPa or more at 260° C., or 45.0 MPa or more at 260° C.

The direct formed polyimide product of the present invention may have a tensile strength of 40.0 MPa or more at 260° C. and a specific gravity of 1.40 or less. Typically, in such embodiments, the formed polyimide product does not comprise a filler (e.g. does not comprise graphite).

The direct formed polyimide product of the present invention may have a tensile strength of 40.0 MPa or more at 260° C. and a specific gravity of 1.50 or less. Typically, in such embodiments, the formed polyimide product does comprise a filler as described above (e.g. comprises 15 wt %±1.0 wt % graphite relative to the weight of the polyimide).

The formed polyimide product of the present invention may have a tensile strength of 110.0 MPa or less, e.g. 105.0 MPa or less, 100.0 MPa or less, 95.0 MPa or less, 90.0 MPa or less, 85.0 MPa or less, 80.0 MPa or less, 75.0 MPa or less, or 70.0 MPa or less.

The presence of an encapsulated filler within the polyimide resin and/or the presence of an additive typically reduces the tensile strength of the polyimide compared to a polyimide which does not comprise an encapsulated filler and/or additive. However the tensile strength of a polyimide according to the present invention which comprises an encapsulated filler and/or additive will typically be greater than was achievable for the same amount of encapsulated and/or blended filer and/or additive in crystalline polyimide products prior to the present invention.

As used herein, the specific gravity of a formed polyimide product is typically relative to deionised water and may be determined by methods known to a skilled person, for example by ASTM D792-20 or by determining the volume of a test body at a specified temperature, typically 20.0° C., (e.g. by measuring the length and diameter of a cylindrical test body with Vernier calipers and calculating the volume of the test body based on the measured length and diameter), measuring the mass of the test body (e.g. on digital scales accurate to within 0.001 g), calculating the density of the test body based on the calculated volume and the measured mass, and expressing the density relative to a literature value for the density of deionised water at the specified temperature (e.g. 0.9982 g cm⁻³ at 20.0° C.).

As used herein, the crystallinity of the formed polyimide product of the present invention is typically as described above with reference to the polyimide of the present invention.

The formed polyimide product of the present invention may be any type of product. Examples include handling machinery parts (e.g. semiconductor handling machinery parts, glass handling machinery parts), chip test sockets, wafer clamping rings, valve seats, products for sealing applications, spline couplings, bearings (e.g. ball bearings), bushings, locking fasteners (e.g. for aerospace), pivot bushings (e.g. for unison ring), and thrust washers.

The present invention also provides an article comprising a formed polyimide product of the present invention. The nature of the article is not particularly limited and will depend on the application of the formed polyimide product. For example, if the formed polyimide product is a semiconductor handling machinery part, the article may be a semiconductor handling machine.

### EXAMPLES

### Example 1

Polyimide powder was produced substantially according to the procedure taught in Example III of U.S. Pat. No. 3,249,588. The production procedure was terminated before the vacuum drying step reported in Example III of U.S. Pat. No. 3,249,588.

The polyimide powder thus obtained was in the form of a wet filter cake and was contacted with supercritical CO₂ in a 25 L supercritical fluid extractor at 80° C. and 150 bar. 8 kg of CO₂ was used in the extraction per kg of polyimide filter cake. A treated polyimide powder was obtained.

### Example 2

A treated polyimide powder was obtained according to the same procedure as Example 1, except that graphite was present in the polyamic-acid solution before conversion to the polyimide. The graphite used was synthetic graphite with a D90 (laser diffraction) of 5.5-6.8 μm. The amount of graphite added was 15 wt %, relative to the weight of the polyimide subsequently obtained.

### Comparative Example 1

A polyimide powder was obtained according to the same procedure as Example 1, and vacuum dried, without the step of contacting the polyimide powder with supercritical C02.

### Comparative Example 2

A polyimide powder was obtained according to the same procedure as Example 2, and vacuum dried, without the step of contacting the polyimide powder with supercritical C02.

### Evaluation

The BET specific surface area of the polyimide powders obtained in Examples 1 and 2 and Comparative Examples 1 and 2 was measured according to ISO 9211:2010 using multi-point determination with N₂ Technical X47S as the adsorptive with a purity of 99.999%, impurities present as H₂O<3 ppm, impurities present as O₂<5 ppm

2.5 mm thick test specimens were prepared from the polyimide powders obtained in Examples 1 and 2 and Comparative Examples 1 and 2 by heating the polyimide powder to 200° C. and then direct forming in an unheated press tool at 100,000 psi and subsequently firing at 400° C. The tensile strength was measured at 23° C. according to ASTM D1708 with a test speed of 1 mm/min.

Crystallinity index was measured by DSC.

Results are provided in Table 1 below.

TABLE 1

| | Tensile | BET specific | | |
|---|---|---|---|---|
| | Strength of | surface area of | | |
| | direct formed | polyimide | | |
| Example | test specimen | powder | Specific | Crystallinity |
| No | (MPa) | (m²/g) | gravity | Index |
| Example 1 | 82.17 | 153.87 | 1.39 | 30 |
| Comparative | 69.43 | 68.88 | 1.36 | 30 |
| Example 1 | | | | |
| Example 2 | 71.33 | 115.69 | 1.46 | 30 |
| Comparative | 63.28 | 56.68 | 1.43 | 30 |
| Example 2 | | | | |

Examples 1 and 2 were also tested to determine tensile strength properties at elevated temperature (260° C.) and the results compared to literature values for Vespel SP1 (unfilled) and Vespel SP21 (15% graphite filled) products. Tensile strength testing was as described above apart from the elevated temperature. Results are shown in Table 2 below.

TABLE 2

| | Tensile Strength of direct formed | Specific |
|---|---|---|
| Example No | test specimen (MPa) | gravity |
| Example 1 (DF) | 43.5 | 1.39 |
| Vespel SP1 (DF) | 36.5 | 1.36 |
| Vespel SP1 (S) | 41.4 | 1.43 |
| Example 2 (DF) | 41.2 | 1.46 |
| Vespel SP21 (DF) | 30.3 | 1.43 |
| Vespel SP21 (S) | 37.9 | 1.51 |

DF = direct formed
S = hot isostatically pressed

The results above show that the polyimide powder according to the invention has a higher BET surface area than a corresponding polyimide powder obtained without the supercritical/low surface tension wash step, and improved tensile strength at ambient and elevated temperatures.

The invention has been described with reference to various non-limiting embodiments and examples. A skilled person will appreciate that various modifications can be made to the embodiments and examples without departing from the scope of protection conferred by the present patent, which shall be determined by the claims, with due account taken of any element which is equivalent to an element specified in the claims.

All documents mentioned herein (including patent documents and non-patent documents) are hereby incorporated by reference in their entirety.

1. A method of treating a polyimide, comprising:
providing a polyimide to be treated; and
contacting the polyimide to be treated with a fluid to obtain a treated polyimide;
wherein the polyimide comprises a first repeat unit derived from pyromellitic dianhydride (PMDA) and a second repeat unit derived from 4,4′-oxodianiline (4,4′-ODA);
and wherein the fluid comprises a supercritical fluid, a liquid with a surface tension of 10.0 mN m⁻¹ or less under the conditions of the contacting step, or a mixture thereof.

2. A method according to claim 1, wherein the fluid comprises a supercritical fluid.

3. A method according to claim 1, wherein the fluid comprises a liquid with a surface tension of 8.5 mN m⁻¹ or less under the conditions of the contacting step.

4. A method according to claim 3, wherein the fluid comprises a liquid with a surface tension of 4.5 mN m⁻¹ or less under the conditions of the contacting step.

5. A method according to any one of the preceding claims, wherein the fluid comprises methane, ethane, ethylene, carbon dioxide, nitrous oxide, or a mixture thereof.

6. A method according to any one of the preceding claims, wherein the polyimide to be treated is poly(PMDA-co-4,4′-ODA).

7. A method according to any one of the preceding claims, wherein the fluid comprises supercritical carbon dioxide and/or liquid carbon dioxide with a surface tension of 2.0 mN m⁻¹ or less.

8. A method according to any one of the preceding claims, wherein the polyimide to be treated is in powder form.

9. A method according to any one of the preceding claims, wherein an encapsulated filler is present within the polyimide to be treated.

10. A method according to claim 9 wherein the encapsulated filler is graphite.

11. A method according to any one of the preceding claims, wherein the treated polyimide does not comprise a encapsulated filler or comprises an encapsulated filler in an amount of 20 wt % or less relative to the weight of the polyimide, and wherein the treated polyimide has a BET specific surface area greater than 100 m² g⁻¹.

12. A method according to any one of claims 1 to 10, wherein the treated polyimide comprises an encapsulated filler in an amount of 20 wt % to 60 wt % relative to the weight of the polyimide, and wherein the treated polyimide has a BET specific surface area greater than 70 m² g⁻¹.

13. A method according to any one of the preceding claims, further comprising a step of mixing the treated polyimide with an additive to obtain a polyimide mixture.

14. A method according to any of the preceding claims further comprising forming the treated polyimide obtained in the method of any one of claims 1 to 11 or the polyimide mixture obtained in the method of claim 12 to obtain a formed polyimide product.

15. A method according to claim 14 wherein the forming is carried out by direct forming to obtain a direct formed polyimide product, or wherein the forming is carried out by hot compression moulding to obtain a hot compression moulded polyimide product, or wherein the forming is carried out by hot isostatic pressing to obtain a hot isostatically pressed polyimide product, or wherein the forming is carried out by ram extrusion to obtain a ram extruded polyimide product.

16. A method according to claim 15 wherein the polyimide product is a direct formed polyimide product and does not comprise an encapsulated filler and has a tensile strength of 80.0 MPa or more and a specific gravity of 1.40 or less.

17. A method according to claim 15 wherein the polyimide product is a direct formed polyimide product, comprises 10 to 20 wt % of an encapsulated filler and has a tensile strength of 70.0 MPa or more and a specific gravity of 1.50 or less.

18. A method according to claim 15 wherein the polyimide product is a hot compression moulded polyimide product, a hot isostatically pressed polyimide product, or a ram extruded polyimide product, does not comprise an encapsulated filler, and has a tensile strength of 90.0 MPa or more.

19. A method according to claim 15 wherein the polyimide product is a hot compression moulded polyimide product, a hot isostatically pressed polyimide product, or a ram extruded polyimide product, comprises 10 to 20 wt % of an encapsulated filler and has a tensile strength of 70.0 MPa or more

20. A treated polyimide obtainable by the method of any one of claims 1 to 12.

21. A polyimide mixture obtainable by the method of claim 13.

22. A polyimide having a BET specific surface area greater than 100 m² g⁻¹, wherein the polyimide comprises a first repeat unit derived from pyromellitic dianhydride (PMDA) and a second repeat unit derived from 4,4′-oxodianiline (4,4′-ODA), and wherein the polyimide does not comprise a encapsulated filler or comprises an encapsulated filler in an amount of 20 wt % or less relative to the weight of the polyimide.

23. A polyimide having a BET specific surface area greater than 70 m² g⁻¹, wherein the polyimide comprises a first repeat unit derived from pyromellitic dianhydride (PMDA) and a second repeat unit derived from 4,4′-oxodianiline (4,4′-ODA), and wherein the treated polyimide comprises an encapsulated filler in an amount of 20 wt % to 60 wt % relative to the weight of the polyimide.

24. A polyimide mixture comprising the polyimide of claim 22 or 23 and an additive.

25. A method of preparing a formed polyimide product, comprising forming the polyimide of claim 22 or 23 or the polyimide mixture of claim 24 to obtain a formed polyimide product.

26. A formed polyimide product obtainable by the method of any one of claims 14 to 19 and 25.

27. A direct formed crystalline polyimide product wherein the polyimide comprises a first repeat unit derived from pyromellitic dianhydride (PMDA) and a second repeat unit derived from 4,4′-oxodianiline (4,4′-ODA), and wherein the direct formed crystalline polyimide product:
does not comprise an encapsulated filler, comprises 0 wt % to 0.5 wt % of an additive relative to the weight of the polyimide, and has a tensile strength of 80.0 MPa or greater; or
comprises 10 wt % to 20 wt % of an encapsulated filler relative to the weight of the polyimide, comprises 0 wt % to 0.5 wt % of an additive relative to the weight of the polyimide, and has a tensile strength of 63.0 MPa or greater; or
comprises 20 wt % to 60 wt % of an encapsulated filler relative to the weight of the polyimide, comprises 0 wt % to 2.0 wt % of an additive relative to the weight of the polyimide, and has a tensile strength of 50.0 MPa or greater; or
comprises 10 wt % to 20 wt % of an encapsulated filler relative to the weight of the polyimide, comprises 5 wt % to 15 wt % of an additive relative to the weight of the polyimide, and has a tensile strength of 52.5 MPa or greater; or
comprises 20 wt % to 60 wt % of an encapsulated filler relative to the weight of the polyimide, comprises 10 wt % to 20 wt % of an additive relative to the weight of the polyimide, and has a tensile strength of 39.5 MPa or greater.

28. A hot isostatically pressed crystalline polyimide product, ram extruded crystalline polyimide product, or hot compression moulded crystalline polyimide product, wherein the polyimide comprises a first repeat unit derived from pyromellitic dianhydride (PMDA) and a second repeat unit derived from 4,4′-oxodianiline (4,4′-ODA), and wherein the hot isostatically pressed crystalline polyimide product, ram extruded crystalline polyimide product, or hot compression moulded crystalline polyimide product:
does not comprise an encapsulated filler, comprises 0 wt % to 0.5 wt % of an additive relative to the weight of the polyimide, and has a tensile strength of 87.0 MPa or greater; or
comprises 10 wt % to 20 wt % of an encapsulated filler relative to the weight of the polyimide, comprises 0 wt % to 0.5 wt % of an additive relative to the weight of the polyimide, and has a tensile strength of 66.0 MPa or greater; or
comprises 20 wt % to 60 wt % of an encapsulated filler relative to the weight of the polyimide, comprises 0 wt % to 2.0 wt % of an additive relative to the weight of the polyimide, and has a tensile strength of 52.5 MPa or greater; or
comprises 10 wt % to 20 wt % of an encapsulated filler relative to the weight of the polyimide, comprises 5 wt % to 15 wt % of an additive relative to the weight of the polyimide, and has a tensile strength of 49.5 MPa or greater; or
does not comprise an encapsulated filler, comprises 10 wt % to 20 wt % of an additive relative to the weight of the polyimide, and has a tensile strength of 59.0 MPa or greater; or
comprises 20 wt % to 60 wt % of an encapsulated filler relative to the weight of the polyimide, comprises 10 wt % to 20 wt % of an additive relative to the weight of the polyimide, and has a tensile strength of 39.5 MPa or greater.

29. An article comprising a formed polyimide product according to any one of claims 26 to 28.
